(19) United States
(12) Patent Application Publication
(10) Pub. No.: US 2019/0034979 A1
(43) Pub. Date: Jan. 31, 2019

(54) SYSTEMS, METHODS, AND APPLICATIONS FOR SOCIAL MEDIA ADVERTISEMENT AND MARKETING MANAGEMENT

(71) Applicant: Telebrands Corp., Fairfield, NJ (US)

(72) Inventor: Ajit KHUBANI, Saddle River, NJ (US)

(21) Appl. No.: 16/047,829

(22) Filed: Jul. 27, 2018

Related U.S. Application Data
(60) Provisional application No. 62/537,698, filed on Jul. 27, 2017.

(51) Int. Cl. G06Q 30/02; G06Q 50/00

(52) U.S. Cl. CPC G06Q 30/0276; G06Q 50/01; G06Q 30/0214; G06Q 30/0277

(57) ABSTRACT

Systems, methods and applications for social media advertisement and marketing management in which a user is provided with, for browsing purposes, a plurality of advertisements relating to products and/or services, a selected advertisement is received from the user, and a unique advertisement and/or referral link associated with the user and the user's selection is generated and provided to the user, and activity associated with the unique advertisement and/or referral link is tracked.

### BACKGROUND

This application claims priority to U.S. Provisional Application Ser. No. 62/537,698, filed on Jul. 27, 2017, which is hereby incorporated by reference herein in its entirety.

### FIELD

Embodiments of the present invention relate to systems, methods, and applications or social media advertisement and marketing management and more particularly for such systems, methods, and applications involving tracking of activity.

### BACKGROUND

With the advent of mobile technology and the growth of social media, advertising and marketing has been shifting away from traditional media outlets, such as television and radio, to more modem media outlets, such as social media (e.g., Facebook, Twitter, Instagram, LinkedIn, etc.) and media content services (e.g., YouTube, etc.). Accordingly, traditional forms of marketing and advertising are not effective in reaching and marketing to the consumers of these newer forms media. Social media has allowed for individuals of fame to promote and market products, with social media postings of such individuals having the potential to reach a wide audience and potentially be re-shared, thereby going “viral”. However, making arrangement for product promotion can be unduly cumbersome, particularly for individuals with lower levels of fame for whom it may not be worth seeking out access to social media marketing arrangements.

### BRIEF SUMMARY OF THE INVENTION

The present invention addresses the above-described deficiencies as well as other deficiencies associated with the prior art. In various aspects of the present invention, systems, methods and applications for social media advertisement and marketing management are provided in which a user is provided with, for browsing purposes, a plurality of advertisements relating to products and/or services, a selected advertisement is received from the user, and a unique advertisement and/or referral link associated with the user and the user selection is generated and provided to the user, and activity associated with the unique advertisement and/or referral link is tracked. The unique advertisement and/or referral link may be posted, and may be posted automatically, to one or a plurality of social media platforms, including blogs.

### BRIEF DESCRIPTION OF THE DRAWINGS

These as well as other features of the present invention will become more apparent upon reference to the drawings wherein:

FIG. 1 is a network architecture on which embodiments of the present invention may be carried out, according to one embodiment of the present disclosure;

FIG. 2 is a flow diagram showing one embodiment of the present invention;

FIG. 3 is a user interface showing a screen with a plurality of product advertisements for selection by a user, according to one embodiment of the present disclosure;

FIG. 4 is a user interface showing a detailed product information screen, according to one embodiment of the present disclosure;

FIG. 5 is a user interface showing an account screen providing for connection and disconnection of social profiles, according to one embodiment of the present disclosure;

FIG. 6 is a user interface showing a reporting screen, according to one embodiment of the present disclosure;

FIG. 7 is an administrative interface showing a user's screen, according to one embodiment of the present disclosure;

FIG. 8 is an administrative interface showing a products screen, according to one embodiment of the present disclosure;

FIG. 9 is an administrative interface showing an edit product screen, according to one embodiment of the present disclosure;

FIG. 10 is an administrative interface showing a posts screen, according to one embodiment of the present disclosure;

FIG. 11 is an administrative interface showing an orders screen, according to one embodiment of the present disclosure; and

FIG. 12 is an administrative interface showing a payouts screen, according to one embodiment of the present disclosure.

### DETAILED DESCRIPTION

Embodiments of the present invention generally relate to a network-based advertisement management system that can facilitate advertising and marketing through social media platforms. Although embodiments of the present invention are described with respect to systems and methods for managing advertising and marketing on social media platforms, the systems and methods described herein are not limited thereto, and can be applicable to managing advertising and marketing through other media.

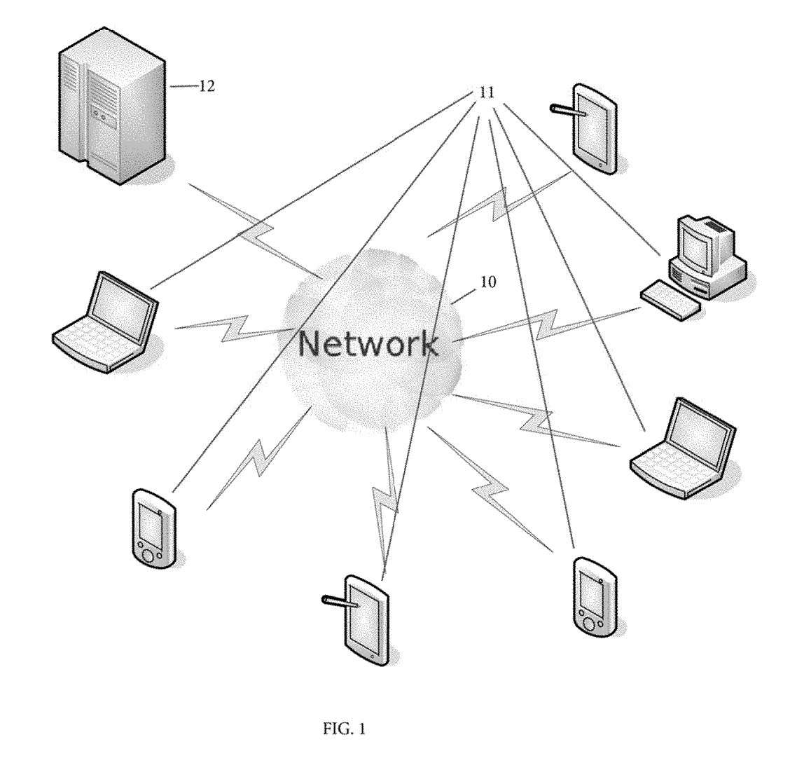

FIG. 1 shows an exemplary social media advertisement management system according to an embodiment of the present invention. As shown in FIG. 1, the exemplary system can include one or more client devices 11 (e.g., smartphones, tablets, laptops, personal computers, etc.) communicating over a connected network 10 (e.g., wireless or wired) to one or more databases 12 (e.g., server, etc.) to enable real-time management of enterprise travel. Each of the client devices 11 can access a web-based application or can include a mobile application that can enable data transmission and communication over the network 10 between the client device 11 and the at least one database 12. According to certain aspects of the present invention, the exemplary systems and methods can facilitate, for example, providing unique advertisements for posting on social media platforms (e.g., Facebook, Twitter, Instagram, Snapchat, LinkedIn, Pinterest, Google+, etc.) and automated real-time tracking and payment associated with such social media advertisements. The unique advertisements can be formatted for posting on the social media platforms, for example, containing words and/or images and an embedded referral link. The unique advertisements may be selectively formatted according to the particular social media (for example, with only text and a referral link being posted to twitter and with text and an image with an embedded referral link being posted to Facebook). The unique advertisements can also be automatically posted on behalf of the user upon the user's authorization for making such post(s), which may require that the system, at that time or a previous time, prompt the user to log in to the social network and provide authorization to the social platform to allow posting on behalf of the user.

According to an embodiment of the present invention, a data store (i.e., database) including one or more (and preferably a plurality of) advertisements is provided for a plurality of, for example, various goods and services. Unique advertisements for each of the plurality of goods and services can be generated and provided and placed on social media platforms, including, but not limited to blogs. For example, a user can utilize is certain embodiments of the present invention (e.g., through a mobile or web-based application) to browse, select and request an advertisement relating to a certain product or service. According to one embodiment, the data store of one or more advertisements for the plurality of goods and services being offered may include a description for each of the plurality goods and/or services, image(s) and/or video(s) and/or other media content (e.g. explorable environment(s) or interactive game(s))of the advertisement that would be provided, and an incentive for the user for placing the advertisement in the user's social media platforms and/or media content providers (e.g., YouTube, Vimeo, Periscope, Facebook, Instagram, Twitter, etc.) in order to allow others to view the advertisement in an effort to make it go “viral.” For example, the user may be offered a reward or a monetary incentive for each good and/or service purchased through the user's uniquely generated advertisement. The incentive may also be non-monetary, for example, a physical or experiential or service reward or rank or access level or a public honor. According to another embodiment, the user may be offered a reward or a monetary incentive for each instance the unique advertisement is posted to a social media platform.

Upon the user's selection of an advertisement, a unique advertisement can be generated and provided to the user. In certain embodiments, the user may select multiple advertisements and opt for the unique advertisements being generated (and/or automatically posted) simultaneously or sequentially or according to a defined schedule. According to one embodiment, the advertisement can include a unique identifier or other unique information associating the advertisement that was generated with the specific user who requested the advertisement. For example, each user may be assigned a unique code that is included in each referral link associated with or embedded in the various unique advertisements generated at the behest of the user, or each unique advertisement may be assigned a unique code that is stored in a server's memory as being associated with the particular user at whose behest the unique advertisement was generated. Accordingly, every user would have a unique advertisement associated with the user to allow for tracking of activity associated with each unique advertisement. According to another embodiment, a referral link with identifier can also or alternatively be generated, for example for use by the user on a blog. The user can then post the generated unique advertisement and/or referral link to one or more of the user's social media platforms, such as Facebook Twitter, Instragram, LinkedIn, Snapchat, Pinterest, Google+ etc. and/or media content providers (e.g., YouTube, Vimeo, Periscope, etc.), which shall also be understood to be social media platforms. For example, the user may post the advertisement in his/her social media feed, post the advertisement in his/her media content provider channel post a link to the advertisement, send it to his/her subscribers, contacts, or friends via direct and/or private message, send it to subscribers, contacts, or friends via email, post it in a friend's or contact's comments section, respond to a friend's or contact's post with the advertisement, etc. According to certain exemplary embodiments, the advertisement may be automatically posted and/or posted by the user in the social media platforms linked to the advertisement database.

After the advertisement has been posted, other users viewing the advertisement can click (or tap) on the advertisement to be directed to a site or a portal where the goods and/or services can be purchased. Other users viewing the advertisement may also “like” the advertisement. Further, embodiments of the present invention can maintain real-time tracking of the activity associated with each generated unique advertisement. For example, the “activity” that can be tracked according to an embodiment of the present invention may include one or more of the number of views, click-throughs, purchases, likes, etc. associated with each unique advertisement. According to an embodiment, this “activity” can be tracked in real-time. Further, embodiments of the present invention can also track any incentive offered to the user or a particular advertisement in real-time as well. Accordingly, a user would be able to see the accumulation of any incentives he/she is set to receive based on activity associated with his/her unique advertisement. Embodiments of the present invention can also facilitate payment of the incentive 116. For example, payment can be made in the form of rewards, coupons, or monetary payments. The payment of the incentives can be made automatically (e.g., one-time payment, periodically, etc.) to any accounts (e.g., a bank account, PayPal, Venmo, Square, etc.) linked to the user.

As shown in FIG. 1, in providing management of advertising and marketing through social media platforms, each mobile client device 11 can include a mobile and/or web-based application. The mobile and/or web-based application can provide a user interface through which a user can, for example, browse and select various advertisements for various goods and/or services. The database 12 of advertisements can be transmitted from the database over a network 10 to the mobile client, and any selection made by the user can be transmitted by the mobile client device 11 over the network 10 to the database 12. Once an advertisement is selected an advertisement unique to the specific user can be generated. The unique advertisement can be generated locally at the mobile device 11, or alternatively, it can be generated at the database 12 and be transmitted to the mobile device 11 via the network 10. The generated advertisement can be automatically posted on the user's social media and/or media content provider platforms. From there, other users can access and/or click on the advertisement to obtain more information on the goods and services and/or purchase the goods and services. Further, the unique identifier or other unique information can be stored on a database, for example, database 12 or a separate tracking database, so that activity associated with the unique advertisement can be tracked.

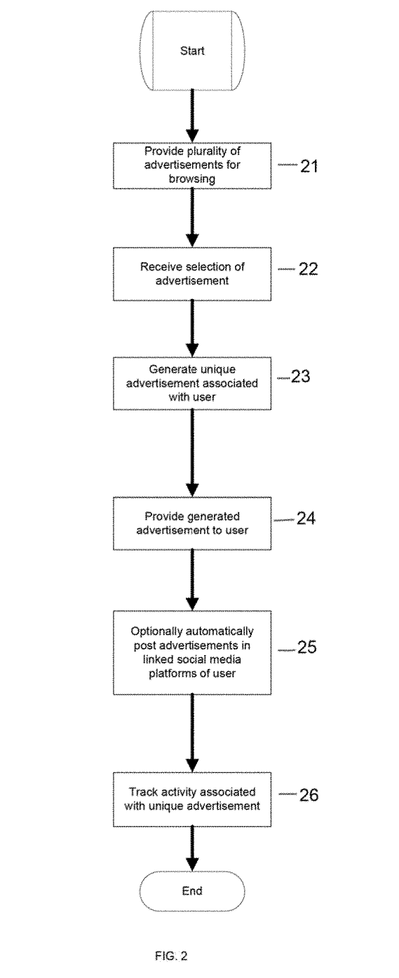

FIG. 2 shows a flow diagram of an exemplary method according to embodiments of the present invention that can be implemented via a mobile or web-based network, such as the network 10 shown in FIG. 1. As shown in FIG. 2, an exemplary method of managing social media based advertisements can be provided. The exemplary method, in step 21, can provide a plurality of advertisements that a user may browse. In step 22, a selection made by the user can be received, and in step 23 a unique advertisement can be generated in response to the users selection. In step 24, the generated advertisement can be provided to the user, and/or in step 25 automatically posted to the user's social media and/or media content platforms. After the advertisement has been posted, in step 26 the activity associated with the advertisement can be tracked.

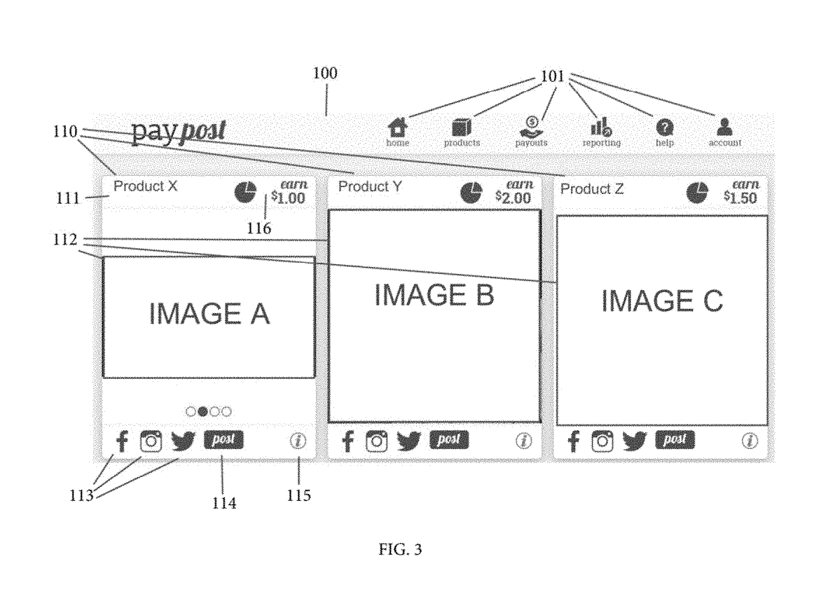

FIG. 3 is a user interface 100 according to an embodiment of the present invention showing a “home” screen with a plurality of product (which will also be understood herein as including a service) advertisements 110 for selection by a user. The user interface 100 may contain one or more tabs 101 directing the user to different screens, such as will be discussed further herein. The product advertisements 110 may all pertain to a specific vendor in certain embodiments, or in an alternate embodiment the product advertisements 110 may be provided by or pertain to different vendors, so as to provide a more encompassing selection of product advertisements 110 to the user. The product advertisements 110 may include or be identified by any combination of a product name 111, one or more product images or videos 112, an incentive 116, social media posting options 113, a post button 114, and/or an additional information link 115. The product images or videos 112 may, as shown in the leftmost product advertisement 110, automatically or manually scroll between different product images or videos, such as by clicking or tapping different circles under them. In certain embodiments, the user can select, such as by tapping or clicking one or more of the product images or videos 112, the ones which will be included in the ultimate social media post. The selected ones may be visually indicated as selected, for example with a checkmark or different coloration. Alternately or in addition, a button (not pictured) may be included that generates a referral link for tracking of sales generated by the user, for example by including such link in blog posts, social media posts, emails, or other forms of communication. Such button may for example appear as the word “blog.”

In certain embodiments, the user can select from amongst the social media posting options 113, such as by tapping or clicking on them. Again, the selected one or ones may be visually indicated as selected, for example with a checkmark or different coloration. In certain embodiments, only social media options 113 with which the user has been connected are shown and/or selectable. In certain embodiments, the user may be limited to selecting a single image or video, while in other embodiments, the user may be able to select multiple for simultaneous inclusion in the generated advertisement. The user may select the post button 114 to automatically post to the selected social media, which in certain embodiments, may post simultaneously to a plurality of selected social media.

An incentive 116 to the user may be displayed on this screen for the product advertisement 110, specified for example as a monetary or percentage or proportion price per consummated sale or post. A pie chart may, in certain embodiments, be used to indicate the percentage or proportion.

The user may search within, or sort, the various product advertisements 110, for example by name or by vendor or supplier (e.g. a user may request to see only Black & Decker or air freshener products, or to sort by vendor name or product category).

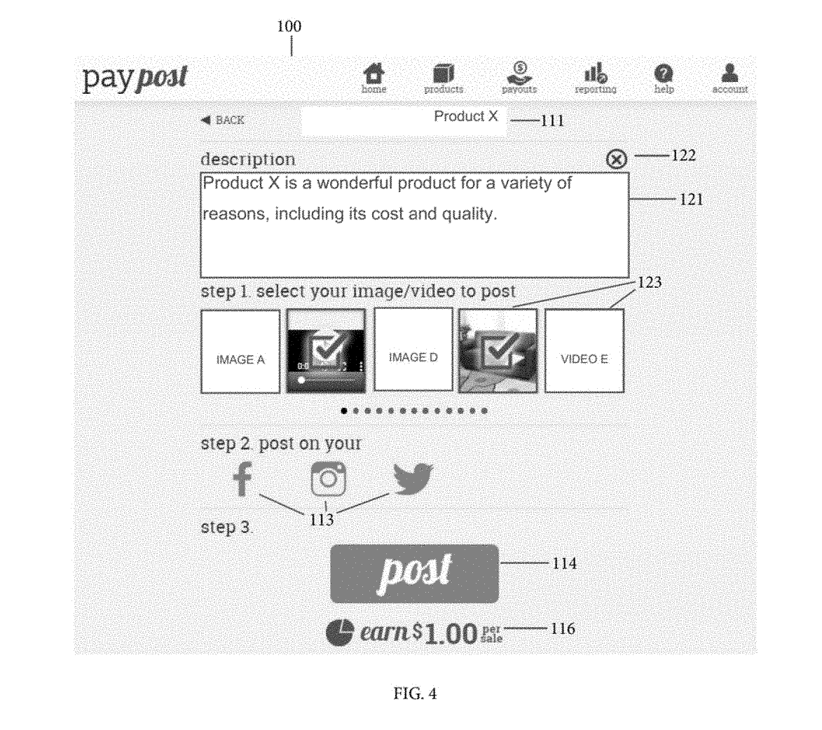

The additional information link 115 may display more detailed information regarding the particular product advertisement 110, for example as discussed below in connection with FIG. 4.

FIG. 4 is a user interface 100 according to an embodiment of the invention showing a detailed product information screen associated which may be associated with a product advertisement 110 as discussed in connection with FIG. 3. The detailed product information screen may include a product name 111, a product description 121, images and/or videos which may be selectable (for example as discussed above in connection with FIG. 3), social media options 113 which may also be selectable (again for example as discussed above in connection with FIG. 3), a post button 114, and/or an incentive 116.

In certain embodiments, the description 121 may be removed at the user's option from the ultimate user-specific advertisement, for example by clicking or tapping removal button 122. In certain embodiments, the user is not given the option to modify is the description 121. This may advantageously streamline the process and allow vendors or operators of the system to control which messages accompany advertisements. However, in other embodiments, the user may be given an option to modify the description 121, for example via an edit link and/or button, with that modified description becoming part of the ultimate user-specific advertisement.

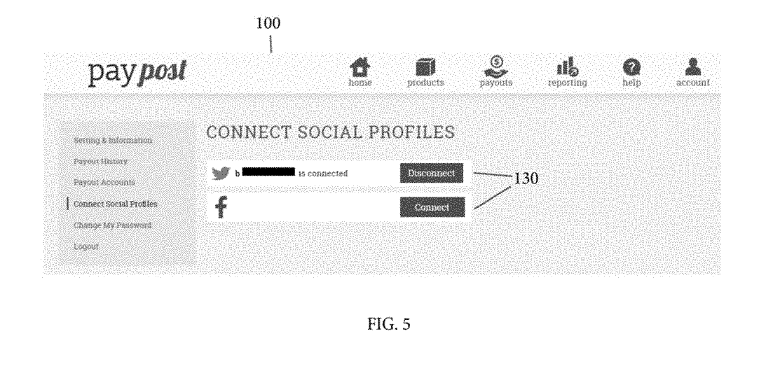

FIG. 5 is a user interface 100 according to certain embodiments of the present invention showing an account screen 130 providing for connection and disconnection of social media profiles. Buttons may be provided to connect to each of one or a plurality of provided social media options. There may be an indication of which social media options are connected, and/or of the particular account name on the social media sites. Other account management features may also be provided, including account settings, account information, payout histories, payout account management, password changes and a logout or login option.

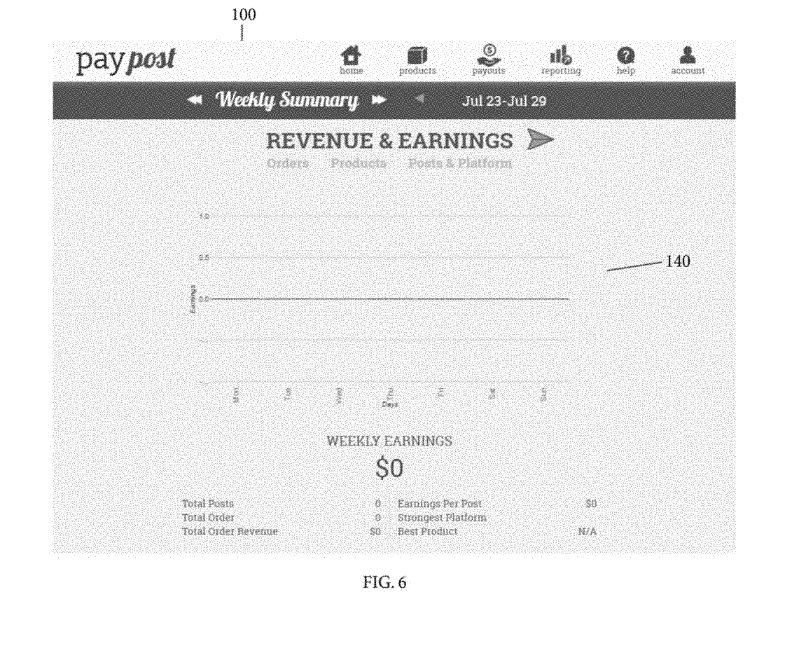

FIG. 6 is a user interface 100 showing a reporting screen 140 according to certain embodiments of the present invention. The user may use such screen for example to track, including during different selectable time periods, earnings, orders through advertisements specific to that user, information pertaining to specific product activity earnings, information pertaining to specific platform activity and earnings, and information pertaining to specific post activity and earnings.

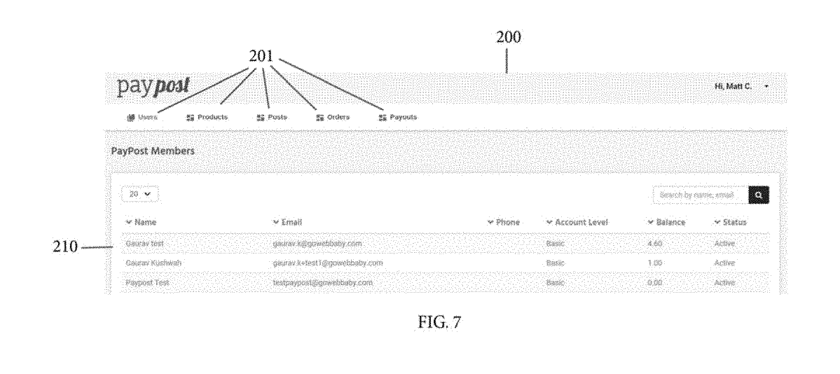

FIG. 7 is an administrative interface 200 according to an embodiment of the invention showing a users screen 210. The administrative interface 200 may contain one or more administrative tabs 201 directing the administrator to different screens, such as will be discussed further herein. Users screen 210 may be used to keep track of different users in the system, and information pertaining to those users, such as their names, contact information (including for example email and/or phone number), account level, account balance, and/or account status. The users may be searchable by the administrator in this interface. Administrative account management features, such as login, logout, change password, grant privileges, etc., may also be provided to the administrator or administrators.

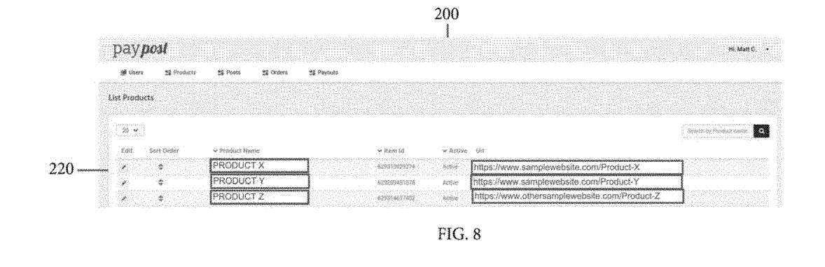

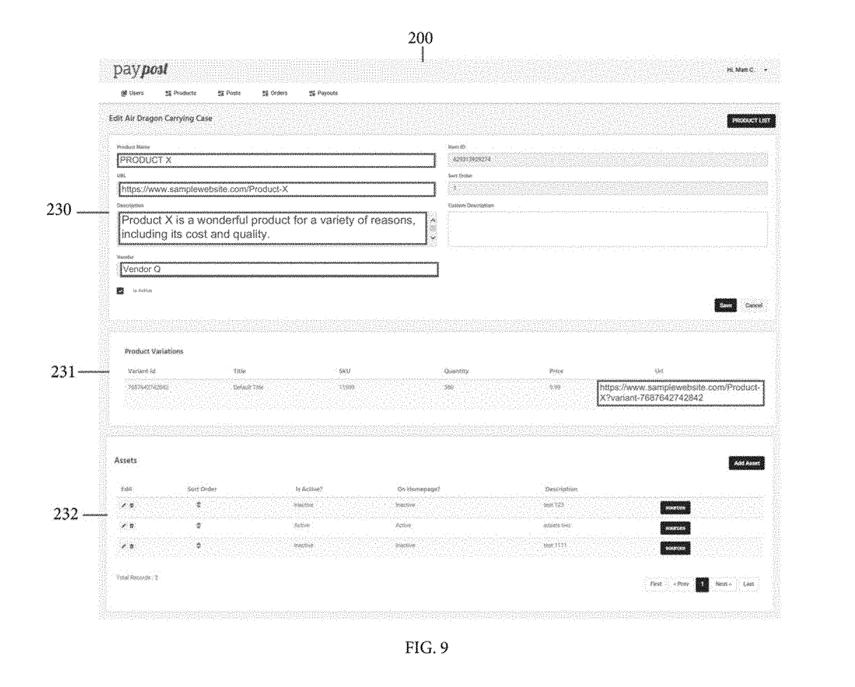

FIG. 8 is an administrative interface 200 according to an embodiment of the present invention showing a products screen 220. Various products may be displayed, along with their unique id, active or inactive status, and/or URL. The products may be searchable by the administrator in this interface. An edit option may also be provided to the administrator for each product, the functionality of which according to certain embodiments will be discussed further in connection with FIG. 9.

FIG. 9 is an administrative interface 200 according to an embodiment of the present invention showing an edit product screen. The edit products screen may include a textual editing portion 230, a listing of product variations 231, and an assets section 232.

The textual editing portion 230 may allow the administrator to modify the product to name, the associated URL, the unique item ID, the order in which the product is shown to users, the description or a custom description (for example, customized for particular users), and the vendor. The textual editing portion 230 may also allow the administrator to select whether the product is active (that is, shown to users and/or selectable by users). Although not shown, the administrator may also select details pertaining to the as incentive 116, such as its numerical amount or proportion or whether it is per post or per sale or per some other metric.

Product variation listing 231 provides for the administrator to create different uniquely identified and/or titled variant offers for the product, to select or keep track of the SKU, the number of advertisements available or products salable under the variation, the price, and/or unique URLs per variant. Different variations may be created for different users, for example based on their account level. Details pertaining to the incentive 116 may also be selected for these variants

Assets section 232 provides for different content, such as photos and/or videos, to be uploaded and selected for use in connection with various product advertisements 110. The order in which the content is shown may also be selected by the administrator, as well as whether the content is currently active or not. A description may be included, to be displayed to the user in association with the content and/or for the administrator's tracking purposes. A sources button may open up an interface allowing for the content to be obtained from, or selectable for use by the user only in connection with, specific social media sites. Content may also be uploaded directly by the administrator to the system.

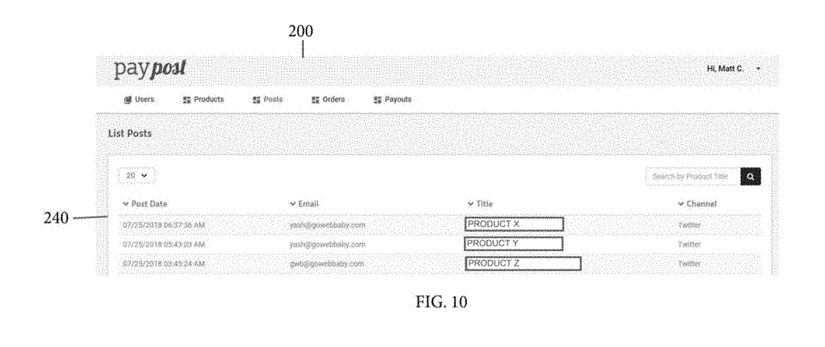

FIG. 10 is an administrative interlace 200 according to an embodiment of the present invention showing a posts screen 240, allowing the administrator to keep track of various posts that have been made by users, including for example by post date, by user email, by title or product name, and/or by social media site. A search function may be provided.

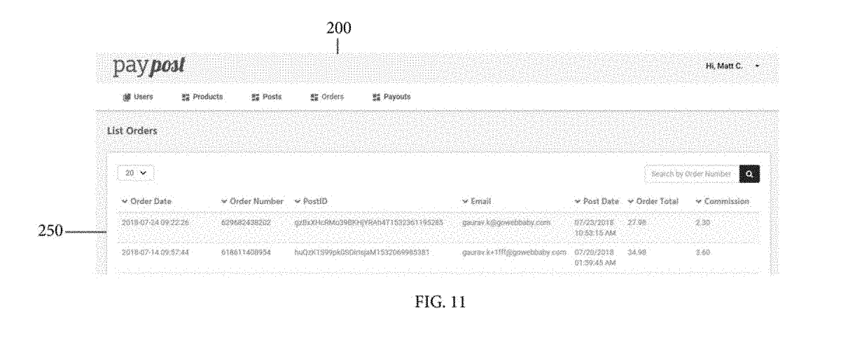

FIG. 11 is an administrative interface 200 according to an embodiment of the invention showing an orders screen 250, allowing the administrator to keep track of various orders that have been effected through user-specific advertisements, including for example by order date, order number, unique ID, user email, post date, order total, and/or user commission. A search function may be provided.

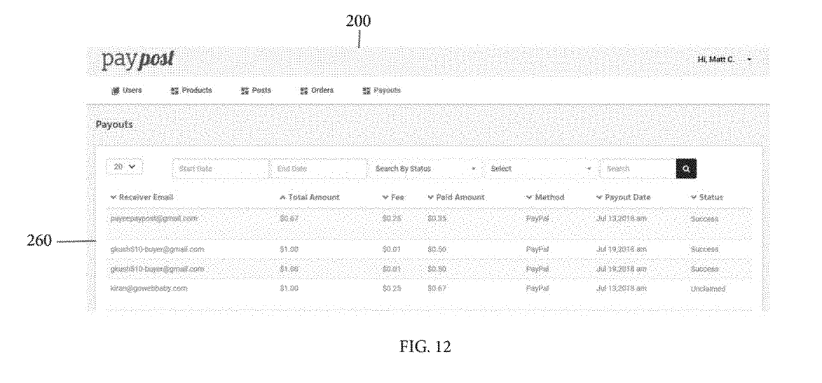

FIG. 12 is an administrative interface 200 according to an embodiment of the invention showing a payouts screen 260, allowing the administrator to keep tracking of payouts to users, for example by receiver email, total amount, fee to the user associated with the payment, paid amount (which may in certain embodiments be the total amount minus user fees), payment method, payout date, and/or status of the payout. A search function may be provided.

In one embodiment, there is a method for social media advertisement and marketing management including: providing, using a computer processor coupled to a data store and in communication through the Internet with a client device accessible to a user, a plurality of advertisements stored in the data store for browsing by the user on the client device; receiving a selection of an advertisement by the user; generating a unique advertisement associated with the user based on the selected advertisement; and tracking activity associated with the unique advertisement.

In an additional embodiment, the method involves connecting the user with a social media platform; and automatically posting the unique advertisement on the social media platform on behalf of the user.

In yet an additional embodiment, the method involves connecting the user with a plurality of social media platforms; receiving an indication from the user, from amongst the plurality of social media options, of at least one social media platform; and automatically posting the unique advertisement on the at least one social media platform. In a further embodiment, the indication from the user of the at least one social media platform is an indication of a plurality of social media platforms, and the unique advertisement is simultaneously automatically posted on the plurality of social media platforms.

In one more embodiment, the method involves the plurality of advertisements including advertisements for different vendors. In a further embodiment, the method further involves allowing the user to search the plurality of advertisements by vendor.

In yet another embodiment, the method involves allowing the user to search the plurality of advertisements by name.

In an additional embodiment, the method involves offering, over the network, a monetary or non-monetary incentive to the user for generating a sale through the unique advertisement; tracking incentives earned by the user as part of the tracking of activity associated with the unique advertisement, receiving, over the network, an indication from the user of how the user would like to receive the incentives earned by the user; and delivering the incentives earned by the user to the user. In a further embodiment, the method involves providing the user with an interface, on the client device, for graphically reviewing, by selectable time period, the incentives earned by the user.

In another embodiment, the method involves allowing the user to browse, on the client device, a plurality of content associated with the selected advertisement; and receiving an indication from the user, from amongst the plurality of content, of at least one piece of content, where the unique advertisement includes the indicated content. In a further embodiment, the plurality of content includes a plurality of photos and/or videos.

In an embodiment, the indication from the user of at least one piece of content includes an indication of a plurality of pieces of content. In a further embodiment, the indication of a plurality of pieces of content includes an indication of a plurality of photos and/or videos. In one more embodiment, the method involves connecting the user with a plurality of social media platforms receiving an indication from the user, from amongst the plurality of social media options, of at least one social media platform; and automatically posting the unique advertisement on the at least one social media platform. In a further embodiment, the indication from the user of the at least one social media platform is an indication of a plurality of social media platforms, and the unique advertisement is simultaneously automatically posted on the plurality of social media platforms.

In an embodiment, the method involves allowing the user to review, on the client device, a textual description; and receiving an indication from the user of whether to include the description, where the unique advertisement selectively includes the textual description based on the user's indication.

In yet one more embodiment, the method involves allowing the user to review and modify, on the client device, a textual description, where the unique advertisement includes the textual description as modified by the user.

In another embodiment, there is a method for social media advertisement and marketing management including: providing, using a computer processor coupled to a data store and in communication through the Internet with a client device accessible to a user, a plurality of advertisements stored in the data store for browsing by the user on the client device; receiving a selection of an advertisement by the user; generating a referral link associated with the user based on the selected advertisement; and tracking activity associated with the referral link. In a further embodiment, the method involves offering, over the network, a monetary or non-monetary incentive to the user for generating a sale through the referral link; tracking incentives earned by the user as part of the tracking, of activity associated with the referral link; receiving, over the network, an indication from the user of how the user would like to receive the incentives earned by the user; and delivering the incentives earned by the user to the user.

In another embodiment, there is a social media advertisement and marketing management system including, (a) a date store containing a plurality of advertisements; and (b) a computer processor coupled to the data store and in communication through the Internet with a client device accessible to a user, the computer processor programmed to provide, over the Internet, the plurality of advertisements to the client device for browsing by the user, further programmed to receive a selection of an advertisement by the user, further programmed to generate a unique advertisement associated with the user based on the selected advertisement, and further programmed to track activity associated with the unique advertisement.

The embodiments and examples shown above are illustrative, and many variations can be introduced to them without departing from the spirit of the disclosure. For example, elements and/or features of different illustrative and exemplary embodiments herein may be combined with each other and/or substituted with each other within the scope of the disclosure. For a better understanding of the disclosure, reference should be had to any accompanying drawings and descriptive matter in which there is illustrated exemplary embodiments of the present invention.

What claimed is:

1. A method for social media advertisement and marketing management comprising:
providing, using a computer processor coupled to a data store and in communication through the Internet with a client device accessible to a user, a plurality of advertisements stored in the data store for browsing by the user on the client device;
receiving a selection of an advertisement by the user;
generating a unique advertisement associated with the user based on the selected advertisement; and
tracking activity associated with the unique advertisement.

2. The method of claim 1, further comprising:
connecting the user with a social media platform; and
automatically posting the unique advertisement on the social media platform on behalf of the user.

3. The method of claim 1, further comprising:
connecting the user with a plurality of social media platforms;
receiving an indication from the user, from amongst the plurality of social media options, of at least one social media platform; and
automatically posting the unique advertisement on the at least one social media platform.

4. The method of claim 3, wherein the indication from the user of the at least one social media platform is an indication of a plurality of social media platforms, and wherein the unique advertisement is simultaneously automatically posted on the plurality of social media platforms.

5. The method of claim 1 wherein the plurality of advertisements comprise advertisements for different vendors.

6. The method of claim 5, further comprising allowing the user to search the plurality of advertisements by vendor.

7. The method of claim 1, further comprising allowing the user to search the plurality of advertisements by name.

8. The method of claim 1, further comprising:
offering, over the network, a monetary or non-monetary incentive to the user for generating a sale through the unique advertisement;
tracking incentives earned by the user as part of the tracking of activity associated with the unique advertisement;
receiving, over the network, an indication from the user of how the user would like to receive the incentives earned by the user; and
delivering the incentives earned by the user to the user.

9. The method of claim 8, further comprising:
providing the user with an interface, on the client device, for graphically reviewing, by selectable time period, the incentives earned by the user.

10. The method of claim 1, further comprising:
allowing the user to browse, on the client device, a plurality of content associated with the selected advertisement; and
receiving an indication from the user, from amongst the plurality of content, of at least one piece of content, wherein the unique advertisement includes the indicated content.

11. The method of claim 10, where the plurality of content comprises a plurality of photos and/or videos.

12. The method of claim 10, wherein the indication from the user of at least one piece of content comprises an indication of a plurality of pieces of content.

13. The method of claim 12, wherein the indication of a plurality of pieces of content comprises an indication of a plurality of photos and/or videos.

14. The method of claim 12, further comprising:
connecting the user with a plurality of social media platforms;
receiving are indication from the user, from amongst the plurality of social media options, of at least one social media platform; and
automatically posting the unique advertisement on the at least one social media platform.

15. The method of claim 14, wherein the indication from the user of the at least one social media platform is an indication of a plurality of social media platforms, and wherein the unique advertisement is simultaneously automatically posted on the plurality of social media platforms.

16. The method of claim 1, further comprising:
allowing the user to review, on the client device, a textual description; and
receiving an indication from the user of whether to include the description, wherein the unique advertisement selectively includes the textual description based on the user's indication.

17. The method of claim 1, further comprising:
allowing the user to review and modify, on the client device, a textual description, wherein the unique advertisement includes the textual description as modified by the user.

18. A method for social media advertisement and marketing management comprising:
providing, using a computer processor coupled to a data store and in communication through the Internet with a client device accessible to a user, a plurality of advertisements stored in the data store for browsing by the user on the client device;
receiving a selection of an advertisement by the user;
generating a referral link associated with the user based on the selected advertisement; and
tracking activity associated with the referral link.

19. The method of claim 18, further comprising:
offering, over the network, a monetary or non-monetary incentive to the user for generating a sale through the referral link;
tracking incentives earned by the user as part of the tracking f activity associated with the referral link;
receiving, over the network, an indication from the user of how the user would like to receive the incentives earned by the user; and
delivering the incentives earned by the user to the user.

20. A social media advertisement and marketing management system comprising:
a data store containing a plurality of advertisements; and
b) a computer processor coupled to the data store and in communication through the Internet with a client device accessible to a user, the computer processor programmed to provide, over the Internet, the plurality of advertisements to the client device for browsing by the user, further programmed to receive a selection of an advertisement by the user, further programmed to generate a unique advertisement associated with the user based on the selected advertisement, and further programmed to track activity associated with the unique advertisement.
